(19) United States
(12) Patent Application Publication
(10) Pub. No.: US 2002/0032286 A1
(43) Pub. Date: Mar. 14, 2002

(54) Epoxidized low viscosity rubber

(76) Inventors: James Robert Erickson, Katy, TX (US); Michael Alan Masse, Richmond, TX (US); David John St.Clair, Houston, TX (US)

Correspondence Address: Donald F. Haas, C/O SHELL OIL COMPANY, Intellectual Property, P.O. Box 2463, Houston, TX, 77056, US

(21) Appl. No.: 09/821,696

(22) Filed: Mar. 29, 2001

Related U.S. Application Data
(63) Continuation of application No. 08/399,865, filed on Apr. 18, 1995, now abandoned.
Application No. 08/399,865 is a division of application No. 08/228,047, filed on Apr. 15, 1994, now abandoned.

(51) Int. Cl. C08F 36/00; C08F 236/00; C08F 36/20; C08F 136/20; C08F 236/08; C08C 19/00; C08F 136/06

(52) U.S. Cl. 525/331.9; 525/332.1; 525/332.8; 525/332.9; 525/333.1; 525/333.2; 525/383

(57) ABSTRACT

An epoxidized low viscosity polydiene polymer which has the structural formula

(A—B—Aₚ)ₙ—Yᵣ—(A_{q}—B)ₘ

wherein Y is a coupling agent or coupling monomers or initiator, and wherein A and B are polymer blocks which may be homopolymer blocks of conjugated diolefin monomers, or copolymer blocks of conjugated diolefin monomers, or copolymer blocks of conjugated diolefin monomers and vinyl aromatic hydrocarbons, the A blocks have a molecular weight of from 100 to 6,000 and the B blocks have a molecular weight of from 1000 to 15,000, n is greater than 0, r is 0 or 1, m is greater than or equal to 0, n+m ranges from 1 to 100, and p and q may be 0 or 1; and wherein the polymer contains from 1.0 to 7.0 milliequivalents of epoxy per gram of polymer.

### BACKGROUND OF THE INVENTION

This invention relates to epoxidized low viscosity polydiene polymers which are suitable for use in blends of aromatic epoxy resins and in blends with cycloaliphatic epoxy resins. More specifically, the invention relates to particular epoxidized low viscosity polydiene polymers which are useful as toughening modifiers for aromatic and cycloaliphatic epoxy resins.

Cured epoxy resins are typically strong, rigid, hard materials. Further, because of their chemical constitution they adhere strongly to many substrate materials. These physical characteristics of cured epoxy resins make them useful in a broad range of applications. One disadvantage of cured epoxy resins is their brittle character. When subjected to impact, cyclic stresses, thermal stresses, or differences in adhesive-substrate expansivities, epoxy resins tend to fail at relatively low applied stresses in a brittle manner. The goal of much effort in this area has been to improve the toughness, or equivalently stated, the energy required to fracture, epoxy resins. Improvements in this regard lead to mechanically superior materials.

Therefore, it would be advantageous if an epoxy resin composition with increased toughness could be achieved. Importantly, the desired increase in toughness must occur with little or no sacrifice in the beneficial mechanical properties of epoxy resins such as strength, rigidity, hardness, and adhesion.

One route to this improvement is to incorporate a rubber into the epoxy matrix. Increases in toughness by incorporation of a rubber phase in an epoxy matrix are well known. Carboxy functional rubbers, as described in commonly assigned U.S. Pat. No. 3,823,107 entitled “Epoxy Resin Curing Agent Compositions, Their Preparation and Use,” have been used as modifiers for epoxy resins. These carboxy functional modifiers suffer the disadvantage that they must be pre-reacted with the epoxy resin before cure so that useful improvements in properties are achieved. Anhydride or acid functional graft copolymers, as described in U.S. Pat. No. 5,115,019 entitled “Carboxy-Functional Hydrogenated Block Copolymer Dispersed in Epoxy Resin,” and U.S. Statutory Invention Registration T4577), entitled “Epoxy Resin Composition,” have been used as modifiers for epoxy resins. These rubbers also suffer the disadvantage that pre-reaction is required. Further, in some cases solvent blending and formation of emulsions of the polymeric modifier is required. The processes required to disperse these polymers possess the further disadvantage that the resulting dispersion of rubber in epoxy is sensitive to the process parameters such as temperature and shear rate during mixing, length of time of mixing, and type and amount of solvent so that inconsistent products are produced with varying properties.

Low viscosity epoxidized polydiene polymers are known to be useful in adhesives. Such polymers are described in commonly assigned U.S. Pat. No. 5,229,464. These polymers have a relatively high degree of flexibility and respond to applied forces in a ductile manner. Compatible blends of the polymers of the above-described patent and epoxy resins are described in allowed copending commonly assigned application Ser. No. 08/090,856, filed Jul. 12, 1993. The blends described in the afore-mentioned patent application have the disadvantage that their compatibility with aromatic and cycloaliphatic epoxy resins is limited. Their limited compatibility does not extend to a broad range of such epoxy resins and curing agents. Compatibilizing curing agents are required. They have the further disadvantage that even when marginally compatible, these polymers do not yield final cured epoxy resins having improved toughness.

The present invention accomplishes the objective of providing novel epoxidized low viscosity polydiene polymers which are highly compatible with aromatic and cycloaliphatic epoxy resins, much more so than are the polymers described in the afore- mentioned U.S. patent application which were described there as having an epoxy content of up to 3 milliequivalents of epoxy per gram of polymer. The low viscosity epoxidized polymers of the present invention yield novel cured epoxy resin compositions having a superior balance of properties. The beneficial properties of the cured epoxy resin composition such as strength, rigidity, and hardness are maintained at high and useful levels while the toughness is simultaneously increased. Therefore, the compositions of the present invention present a broad utility. Additionally, the epoxidized polymers of the present invention are simply blended with epoxy resins before cure with no pre-reaction or solvent required.

### SUMMARY OF THE INVENTION

This invention is an epoxidized low viscosity polydiene polymer. The polymers are block copolymers of at least two conjugated dienes, preferably isoprene and butadiene, and optionally, a vinyl aromatic hydrocarbon.

The epoxidized low viscosity polydiene polymer of the present invention has the structural formula

(A—B—Aₚ)ₙ—Yᵣ—(A_{q}—B)ₘ

wherein Y is a coupling agent or coupling monomers or initiator, and wherein A and B are polymer blocks which may be homopolymer blocks of conjugated diolefin monomers, copolymer blocks of conjugated diolefin monomers, or copolymer blocks of diolefin monomers and monoalkenyl aromatic hydrocarbon monomers. These low viscosity polymers may contain up to 60% by weight of at least one vinyl aromatic hydrocarbon, preferably styrene. Generally, it is preferred that the A blocks should have a greater concentration of more highly substituted aliphatic double bonds than the B blocks have. Thus, the A blocks have a greater concentration of di-, tri-, or tetra-substituted unsaturation sites (aliphatic double bonds) per unit of block mass than do the B blocks. This produces a polymer wherein the most facile epoxidation occurs in the exterior blocks. The A blocks have a molecular weight of from 100 to 6000, preferably 100 to 3,000, and most preferably 500 to 2000, and the B blocks have a molecular weight of from 1000 to 15,000, preferably 3000 to 7000, and most preferably 3000 to 7000. n is greater than 0, r is 0 or 1, m is greater than or equal to 0, and n+m ranges from 1 to 100. p and q may be 0 or 1. The epoxidized polymers have an epoxy content of from 1.0 to 7.0 milliequivalents of epoxy per gram of polymer (meq/g). The polymer may contain hydroxl functionality and may be hydrogenated. Generally, the polymers have an overall molecular weight (peak, as determined by GPC) of from 1000 to 300,000, preferably 1000 to 100,000, and most preferably 1000 to 20,000, and preferably are liquids.

### DETAILED DESCRIPTION OF THE INVENTION

Polymers containing ethylenic unsaturation can be prepared by copolymerizing one or more olefins, particularly diolefins, by themselves or with one or more alkenyl aromatic hydrocarbon monomers. The copolymers may, of course, be random, tapered, block or a combination of these, as well as linear, star or radial.

The polymers containing ethylenic unsaturation or both aromatic and ethylenic unsaturation may be prepared using anionic initiators or polymerization catalysts. Such polymers may be prepared using bulk, solution or emulsion techniques. When polymerized to high molecular weight, the polymer containing at least ethylenic unsaturation will, generally, be recovered as a solid such as a crumb, a powder, a pellet or the like. When polymerized to low molecular weight, it may be recovered as a liquid such as in the present invention. Polymers containing ethylenic unsaturation and polymers containing both aromatic and ethylenic unsaturation are available commercially from several suppliers.

In general, when solution anionic techniques are used, copolymers of conjugated diolefins and alkenyl aromatic hydrocarbons are prepared by contacting the monomer or monomers to be polymerized simultaneously or sequentially with an anionic polymerization initiator such as group IA metals, their alkyls, amides, silanolates, napthalides, biphenyls or anthracenyl derivatives. It is preferred to use an organo alkali metal (such as sodium or potassium) compound in a suitable solvent at a temperature within the range from about −150° C. to about 300° C., preferably at a temperature within the range from about 0° C. to about 100° C. Particularly effective anionic polymerization initiators are organo lithium compounds having the general formula:

RLiₙ

wherein R is an aliphatic, cycloaliphatic, aromatic or alkyl-substituted aromatic hydrocarbon radical having from 1 to about 20 carbon atoms and n is an integer of 1 to 4.

Conjugated diolefins which may be polymerized anionically include those conjugated diolefins containing from about 4 to about 24 carbon atoms such as 1,3-butadiene, isoprene, piperylene, methylpentadiene, phenyl-butadiene, 3,4dimethyl-1,3-hexadiene, 4,5-diethyl-1,3-octadiene and the like. Isoprene and butadiene are the preferred conjugated diene monomers for use in the present invention because of their low cost and ready availability. Alkenyl (vinyl) aromatic hydrocarbons which may be copolymerized include vinyl aryl compounds such as styrene, various alkyl-substituted styrenes, alkoxy-substituted styrenes, vinyl napthalene, alkyl-substituted vinyl napthalenes and the like.

The epoxidized low viscosity polymers of the present invention have the general formula

(A—B—Aₚ)ₙ—Yᵣ—(A_{q}—B)ₘ

wherein Y is a coupling agent or coupling monomers or initiator, and wherein A and B are polymer blocks which may be homopolymer blocks of conjugated diolefin monomers, copolymer blocks of conjugated diolefin monomers, or copolymer blocks of diolefin monomers and monoalkenyl aromatic hydrocarbon monomers. The polymer may contain up to 60% by weight of a vinyl aromatic hydrocarbon, preferably styrene. Polymers of this type are described in more detail in U.S. Pat. No. 5,229,464 which is herein incorporated by reference. Generally, it is preferred that the A blocks should have a greater concentration of more highly substituted aliphatic double bonds than the B blocks have. Thus, the A blocks have a greater concentration of di-, tri-, or tetra-substituted unsaturation sites (aliphatic double bonds) per unit of block mass than do the B blocks. This produces a polymer wherein the most facile epoxidation occurs in the exterior blocks. The A blocks have a molecular weight of from 100 to 6,000, preferably 100 to 3000, most preferably 500 to 2000, and the B blocks have a molecular weight of from 1000 to 15,000, preferably 3000 to 7000, most preferably to 2000 to 6000. n is greater than 0, r is 0 or 1, m is greater than or equal to 0, and n+m ranges from 1 to 100. p and q may be 0 or 1.

When the concentration of alkenyl aromatic hydrocarbon monomer in the epoxidized polymer is less than-or equal to 5% by weight, the concentration of epoxide may range from 3 to 7 meq/g of polymer. When the concentration of alkenyl aromatic hydrocarbon monomer is from 5% up to 20% by weight, the concentration of epoxide may range from 2 to 7 meq/g of polymer. When the concentration of monoalkenyl aromatic hydrocarbon is from 20% to 60% by weight, the concentration of epoxide may range from 1 to 7 meq/g of polymer. If the epoxy levels are any lower, the components are not sufficiently compatible to toughen aromatic epoxy resins. Also, at lower levels, the mixing temperature required to adequately mix the polymer with an aromatic epoxy resin will have to be undesirably high. At higher epoxy levels, the polymers will be too compatible and soluble with an aromatic epoxy resin to achieve the desired phase separation upon curing as described in copending, commonly assigned U.S. patent application Ser. No. ______, entitled “Epoxidized Low Viscosity Rubber Toughening Modifiers for Epoxy Resins”, filed concurrently herewith, which is herein incorporated by reference. It will also raise the viscosity and the cost without any corresponding benefit.

The preferred epoxy levels are 3.5 to 6 meq/g for less than 5% vinyl aromatic hydrocarbon, 3 to 6 for 5 to 20%, and 1.5 to 6 for 20 to 60%. If the epoxy levels are lower, then cloud points of 85° C. or lower for blends with aromatic epoxy resins cannot be achieved without additional formulating ingredients. This is an indication of a uniform, compatible blend with uniform appearance and feel. Higher epoxy levels are not preferred for the same reason and also that they increase the viscosity and cost without any appreciable benefit.

It has been found that by the proper combination of unsaturation, epoxide level, and alkenyl aromatic monomer content, a low viscosity polydiene which possesses suitable compatibility with epoxy resins to yield an improved balance of properties can be made. The diene monomers remain unsaturated before epoxidation in the preferred polymers. When alkenyl aromatic monomers are present at concentrations of less than 5% by weight, the most preferred epoxide level ranges from 4.5 to 5.5 meq/g of polymer. When alkenyl aromatic monomers are incorporated at levels of 5% up to 20% by weight in the largely unsaturated polydiene block copolymer, its compatibility with epoxy resin is improved to such a degree that lower levels of epoxidation will yield improved rubber modified epoxy resins and the most preferred range is 4 to 5.5. When alkenyl aromatic monomers are present at concentrations of 20% to 60% by weight or greater, the most preferred epoxide level ranges from 2 to 4.5 meq/g of polymer. These ranges are believed to be optimum because they allow aromatic epoxy resin blends to be made with a cloud point of no more than 60° C. (low end of range) and as low as 40 to 50° C. (high end of range). It is believed that such compositions have the proper phase separation to achieve compositions with the best combination of properties, appearance, and feel.

Within these ranges of epoxy content and the above molecular weight ranges, these low viscosity polymers exhibit a high degree of compatibility for both aromatic and cycloaliphatic epoxy resins, which makes them very useful in “toughening” such resins so they can be better utilized in applications such as structural adhesives and coatings, especially primers. The ability to form suitably compatible blends with epoxy resins is one primary feature of the molecules of the -present invention. While the preferred epoxidized polymers are largely unsaturated, analogous hydrogenated polymers may also be suitable. In polymers of high epoxy and styrene content it is anticipated that suitable compatibility with epoxy resins will result even when all the unsaturation is consumed by hydrogenation. These polymers offer the further advantages of improved chemical resistance and improved thermo-oxidative, oxygen, ozone and ultraviolet stability.

The most highly preferred low viscosity polymers for use herein are diblock polymers which fall within the scope of the formula above. The overall molecular weight of such diblocks may range from 1500 to 15000, preferably 3000 to 7000. Either of the blocks in the diblock may contain some randomly polymerized vinyl aromatic hydrocarbon as described above. For example, where I represents isoprene, B represents butadiene, S represents styrene, and a slash (/) represents a random copolymer block, the diblocks may have the following structures:

I-B I-B/S I/S-B I-B/I B/I-B/S B-B/S or

B_{Mono-substituted}-B_{Di-substituted}

and all mirror images of the above. These diblocks are advantageous in that they exhibit lower viscosity and are easier to manufacture than the corresponding triblock polymers.

Blends of epoxy resins with the higher epoxy content polymers of the present invention are physically different than blends of epoxy polymers with the lower epoxy content epoxidized polymers of U.S. Pat. No. 5,229,464 and the afore-mentioned copending patent application. The blends of the present invention are stronger and more rigid. The uses for the blends of the present invention are ones which require a modified epoxy composition with better toughness and strength than the blends of the copending patent application. It appears that the improved compatibility of the polymers of the present invention results in modified epoxy resins in which there is better interfacial bonding between the dispersed epoxidized polymers and the epoxy resin matrix. This improved compatibility is due to the presence of greater amounts of epoxy and, in some polymers, the presence of significant amounts of a vinyl aromatic hydrocarbon.

Molecular weights of linear polymers or unassembled linear segments of polymers such as mono-, di-, triblock, etc., arms of star polymers before coupling are conveniently measured by Gel Permeation Chromatography (GPC), where the GPC system has been appropriately calibrated. For polymers of the type described herein, the appropriate standard is a narrow molecular weight polystyrene standard. For anionically polymerized linear polymers, the polymer is essentially monodisperse and it is both convenient and adequately descriptive to report the “peak” molecular weight of the narrow molecular weight distribution observed. The peak molecular weight is usually the molecular weight of the main species shown on the chromatograph. For materials to be used in the columns of the GPC, styrene-divinyl benzene gels or silica gels are commonly used and are excellent materials. Tetrahydrofuran is an excellent solvent for polymers of the type described herein. Ultraviolet or refractive index detectors may be used.

Measurement of the true molecular weight of a coupled star polymer is not as straightforward or as easy to make using GPC. This is because the star shaped molecules do not separate and elute through the packed GPC columns in the same manner as do the linear polymers used for the calibration. Hence, the time of arrival at an ultraviolet or refractive index detector is not a good indicator of the molecular weight. A good method to use for a star polymer is to measure the weight average molecular weight by light scattering techniques. The sample is dissolved in a suitable solvent at a concentration less than 1.0 gram of sample per 100 milliliters of solvent and filtered using a syringe and porous membrane filters of less than 0.5 microns pour sized directly into the light scattering cell. The light scattering measurements are performed as a function of scattering angle, polymer concentration and polymer size using standard procedures. The differential refractive index (DRI) of the sample is measured at the same wave length and in the same solvent used for the light scattering. The following references are herein incorporated by reference:

1. Modern Size-Exclusion Liquid Chromatography, M. W. Yau, J. J. Kirkland, D. D. Bly, John Wiley and Sons, New York, N.Y., 1979.

2. Light Scattering From Polymer Solutions, M. B. Huglin, ed., Academic Press, New York, N.Y., 1972.

3. W. K. Kai and A. J. Havlik, Applied Optics, 12, 541 (1973).

4. M. L. McConnell, American Laboratory, 63, May, 1978.

If desired, these block copolymers can be partially hydrogenated. Hydrogenation may be effected selectively as disclosed in U.S. Patent Reissue 27,145 which is herein incorporated by reference. The hydrogenation of these polymers and copolymers may be carried out by a variety) of well established processes including hydrogenation in the presence of such catalysts as Raney Nickel, nobel metals such as platinum and the like, soluble transition metal catalysts and titanium catalysts as in U.S. Pat. No. 5,039,755 which is also incorporated by reference. The polymers may have different diene blocks and these diene blocks may be selectively hydrogenated as described in U.S. Pat. No. 5,229,464 which is also herein incorporated by reference.

The polymers of this invention may be combined with aromatic epoxy resins to form toughened epoxy resin compositions which may be used in a broad variety of applications. They are useful in adhesives, including contact adhesives, laminated adhesives and assembly adhesives, but they have special utility in structural adhesives where they may be combined with a broad range of curing agents to form excellent products which adhere to metals, plastic, wood, glass, and other substrates. They also have special utility in coatings (especially primers, topcoats for automotive, epoxy primers for metal, polyester coil coatings, alkyd maintenance coatings, etc.) where they may be combined with pigments and curing agents to form excellent products. Other applications for these compositions include electrical applications such as castings, encapsulants, potting compounds, solder masking compounds, and laminates and construction applications such as flooring, civil engineering, concrete repair and consolidation, secondary containment of tankage, grouts, sealants, polymer concrete, structural composites, tooling, etc.

The polymers of this invention may also be combined with cycloaliphatic epoxy resins as described in copending, commonly assigned U.S. patent application Ser. No. ______, entitled “Epoxidized Low Viscosity Rubber Toughening Modifiers for Cycloaliphatic Epoxy Resins”, filed concurrently herewith, which is herein incorporated by reference. Such toughened cycloaliphatic epoxy resin compositions may be used in a variety of applications. They have special utility in structural adhesives and coatings where they may be combined with anhydride curing agents or catalytic curing agents to form excellent, impact resistant products. They have special utility in coatings, where they may be combined with a cationic photoinitiator and, after application to a substrate, can be cured by exposure to UV radiation to form excellent, flexible products. Other applications for these compositions include electrical castings, encapsulants, potting compounds, laminates, and construction adhesives.

These polymers may also be used in pressure sensitive adhesives, films (such as those requiring heat and solvent resistance), molded and extruded thermoplastic and thermoset parts (for example, thermoplastic injection molded polyurethane rollers or reaction injection molded thermoset auto bumper, facie, cast urethane parts, etc.), in the modification of engineering plastics (such as polycarbonate and polyphenylene ether), in printing plates, and in the modification of asphalt.

### EXAMPLES

Several performance properties of the cured modified epoxy resin compositions of the present invention are important. The tensile properties such as strength, elongation, and Young's modulus are measured according to ASTM D-638. The flexural properties such as flexural modulus, stress and strain at failure are measured according to ASTM D-790. The tensile fracture toughness as characterized by the stress intensity factor (K_{IC}) for crack propagation is measured according to ASTM E-399-83. Using the value of K_{IC} so measured, the fracture energy (G_{IC}) was calculated for the plane strain conditions employed. The adhesive properties such as lap shear stress are measured according to ASTM D-1002. The glass transition temperature (T_{g}) is measured using torsional bar dynamic mechanical analysis.

Table I below describes the composition of the epoxidized polydiene polymers used in the following examples which describe experiments performed with aromatic epoxy resins.

TABLE I
Composition of Epoxidized Polymers

| | Base | Molecular | Styrene | Epoxy | Hydro- |
|---|---|---|---|---|---|
| Identifi- | Polymer | Weights | Content | Level | genated |
| cation | Architecture | (in thousands) | (%) | (meq/g) | (Y/N)* |
| A | I-B | 0.88-4.08 | 0 | 5.2 | N |
| B | I-B | 0.88-4.08 | 0 | 4.3 | N |
| C | I-B | 0.88-4.08 | 0 | 3.6 | N |
| D | I/S-B-I/S | 1.18/0.68-3.82- | 16 | 2.2 | N |
| | | 0.68/0.39 | | | |
| E | I/S-B-I/S | 1.18/0.68-3.82- | 16 | 3.4 | N |
| | | 0.68/0.39 | | | |
| F | I/S-B | 1.18/0.68-3.82 | 12 | 4.4 | N |
| G | I/S-B | 1.18/0.68-3.82 | 12 | 4.9 | N |
| H | I-S/B-I | 1.0-2.5/1.5-1.0 | 39 | 2.2 | N |
| I | (I-B)₄ | (0.9-4.5)4 | 0 | 0.7 | N |
| II | I-S/B-I | 1.0-2.5/1.5-1.0 | 39 | 1.2 | Y |
| III | I/S-B-I/S | 1.18/0.68-3.82- | 16 | 0.8 | N |
| | | 0.68/0.39 | | | |

*Y = Yes, N = No

In the base polymer architecture column of Table I, B represents poly(1,3-butadiene) blocks, I represents polyisoprene blocks, and S represents polystyrene blocks, respectively. All blocks are separated by a dash. Random copolymer blocks are represented by I/S and S/B for randomly copolymerized isoprene and styrene and randomly copolymerized styrene and butadiene, respectively. A polar cosolvent, diethyl ether, was used as part of the polymerization solvent system, cyclohexane, during the synthesis of the I/S and B/S blocks to encourage randomization. Star or radial polymers having n arms are represented in parentheses, ( ).

During the anionic synthesis of the base polymers A, B, C, and I, the isoprene monomer was polymerized in cyclohexane solvent alone (no polar cosolvent present) to encourage formation of primarily 1,4-polybutadiene blocks. Enough diethyl ether was added to give about 10% by weight diethyl ether in the final solution. The presence of the polar cosolvent caused the butadiene to polymerize about equally in both the 1,4 and 1,2 microstructures. All of the blocks in polymers D, E, F, G, H, II, and III were polymerized in the presence of about 6 to 10% by weight diethyl ether cosolvent and the polyisoprene thus has significant amounts of both the 1,4 and 3,4 microstructures and the polybutadiene has both the 1,2 and 1,4 microstructures. Polymer II was partially hydrogenated prior to epoxidation. It had about 1.7 meq/g of polymer of residual unsaturation which was almost entirely in the polyisoprene blocks.

For all of the polymers, the epoxidation was carried out in the polymerization solvent using peracetic acid solution from FMC Corp. The method is generally described in U.S. Pat. No. 5,229,464 which is herein incorporated by reference. The polymers were washed and recovered by vacuum drying.

In addition to the 5.2 meq/g of epoxide on Polymer A, it also contained about 1 meq/g of derivatized epoxide. According to C¹³ NMR analysis, the derivative was primarily the hydrolysis product of the epoxide, consisting of secondary and tertiary alcohol groups. Since 1 meq of epoxide can generate two meq of OH, there was about 2 meq/g of these hydroxyls in Polymer A. The presence of these hydroxyl groups win make hydrogenated versions of these polymers more compatible with the aromatic and cycloaliphatic epoxy resins. A very small amount of the acetic ester-alcohol derivative was also observed. Polymer B had a smaller amount of derivatized epoxide and Polymer C had no detectable derivatized epoxide functionality.

Epoxy resins used herein include the commercially-available epoxy resin EPON® Resin 828, a reaction product of epichlorohydrin and 2,2-bis(4-hydroxyphenylpropane) (bisphenol-A) having a molecular weight of about 400, an epoxide equivalent (ASTM D-1652) of about 185-192, and an n value (from the formula above) of about 0.13, and EPON® 826, a reaction product of epichlorohydrin and bisphenol-A with an n value of about 0.08.

Aliphatic epoxy resins used herein as flexibilizers are the HELOXY® series resins (aliphatic mono-, di-, and multi-functional epoxies made by Shell Chemical Company) EPON® 871 (diglycidyl aliphatic ester epoxy made by Shell Chemical Company), and UVR-6110 (a difunctional cycloaliphatic epoxy made by Union Carbide Corporation).

Curing agents used herein include phthalic anhydride (PA), tetrahydrophthalic anhydride (THPA), nadic methyl anhydride (NMA), hexahydrophthalic anhydride (HHPA), pyromellitic dianhydride (PMDA), methyltetrahydro-phthalic anhydride (MTHPA), and dodecenylsuccinic anhydride (D)SA), and the like. Curing accelerators used herein include trialkyl amines, hydroxyl-containing compounds and imidazoles. Benzyldimethylamine (BDMA), 2-ethyl-4-methylimidazole (EMI and BF₃ amine complexes have been used. Aliphatic amines such as diethylene triamine (DETA) and triethylene tetraamine (TETA) have been used for curing the modified epoxy resins. Aromatic amines such as diethyltoluenediamine and metaphenylenediamine (MPDA) have also been used. Polyamides such as EPI-CURE® 3140 polyamide curing agent supplied by Shell Chemical Company are also useful in the cure of the modified epoxy compositions. Benzyldimethylamine (BDMA) has been used.

### Example 1

The compatibility of the epoxidized polymers in blends with EPON® 826 epoxy resin was evaluated by measurement of their cloud points. The cloud point is defined as that temperature at which the blend becomes turbid. The turbidity of the blend indicates formation of a phase separated morphology with particles of sufficient size to scatter light. Epoxidized polymer/epoxy resins blends with excessively high (>150° C.) cloud points are not useful for the present invention because this prohibits mixing of the epoxidized polymer and epoxy resin.

In this example blends of epoxidized polymers having the structure I-B or (I-B)ₙ with EPON® 826 resin are demonstrated and compared. Table II lists the cloud points for blends at various epoxidized polymer concentrations.

TABLE II
Cloud Points of Blends of Epoxidized Polymer with
EPON ® 826 at Various Epoxidized Polymer Levels

| | Cloud Point (° C.) | | | | |
|---|---|---|---|---|---|
| Epoxidized | @ 10% | @ 20% | @ 30% | @ 40% | @ 50% |
| Polymer | Polymer | Polymer | Polymer | Polymer | Polymer |
| A | 46 | 37 | 28 | <22 | <22 |
| B | 82 | 74 | 62 | 49 | 34 |
| C | 123 | 118 | 108 | 102 | 88 |
| I | >150 | >150 | — | — | — |

The cloud point of epoxidized polymers A, B, and C are well below 150° C. at concentrations up to 50% polymer. Thus, epoxidized polymers A, B, and C are suitable for use in the present invention. The comparative polymer I (which has a similar structure) is unable to be mixed with EPON® 826 resin because of its excessively high cloud point. Comparative polymer I corresponds directly to polymer 103 (0.7 meq/g of epoxy) of the afore-mentioned patent application. This demonstrates that polymers of the structure I-B or (I-B)ₙ require epoxy levels greater than 0.7 meq/g to be useful.

### Example 2

The cloud point of blends of epoxidized polymers having the structure I/S-B-I/S and I/S-B and EPON® 826 epoxy resin were measured as in Example I. Table III lists the cloud points for blends of various epoxidized polymer level.

TABLE III
Cloud Points of Blends of Epoxidized Polymer with
EPON ® 826 at Various Epoxidized Polymer Levels

| | Cloud Point (° C.) | | | | |
|---|---|---|---|---|---|
| Epoxidized | @ 10% | @ 20% | @ 30% | @ 40% | @ 50% |
| Polymer | Polymer | Polymer | Polymer | Polymer | Polymer |
| D | 114 | — | — | — | — |
| E | 102 | 106 | — | — | — |
| F | 66 | 60 | 52 | 43 | 36 |
| G | 62 | 57 | 46 | 37 | 25 |
| III | >150 | >150 | — | — | — |

The cloud point of epoxidized polymers D through G are well below 150° C. at concentrations up to 50%. These polymers contain at least 12% styrene monomer by weight. At these concentrations, polymer D is suitable for use in the present invention at an epoxy level of 2.2 meq/g. Likewise, polymers E, F, and G, all at higher epoxy levels, are also suitable for use in the present invention. However, comparative polymer III (which has a similar structure) with 16% by weight styrene and an epoxy level 0.8 meq/g of polymer has an excessively high cloud point and cannot be mixed with EPON® 826 resin.

### Example 3

The cloud points of blends of epoxidized polymers having the structure I-S/B-I and EPON® 826 resin were measured as in Example 1. Table IV lists the cloud points for blends at various epoxidized polymer concentrations.

TABLE IV
Cloud Points of Blends of Epoxidized Polymer with
EPON ® 826 at Various Epoxidized Polymer Levels.

| | Cloud Point (° C.) | | |
|---|---|---|---|
| Epoxidized | @ 10% | @ 20% | @ 30% |
| Polymer | Polymer | Polymer | Polymer |
| H | 72 | — | 70 |
| II | >150 | >150 | — |

The cloud point of the blend of epoxidized polymer H and EPON® 826 resin is well below 150° C. and so is suitable for use in the present invention. Polymer H has an epoxy level of 2.2 meq/g and is not hydrogenated. The cloud point of the blend containing comparative polymer II (which has a similar structure) is excessively high and polymer II cannot be mixed with EPON® 826 resin and so is unsuitable for use in the present invention. Comparative polymer II has an epoxy level of 1.2 meq/g and the diene monomer units have been hydrogenated. Comparative polymer II corresponds directly to polymer 204 of the afore-mentioned patent application.

### Example 4

The compatibility of epoxidized polymer C, having the structure I-B, with a mixture of EPON® 828 resin, a diglycidyl ether of bisphenol-A, and UVR-6110, a cycloaliphatic epoxy resin is described. Table V lists the cloud points for the blends having 10% and 20% epoxidized polymer.

TABLE V
Cloud Points of Ternary Blends of
Epoxidized Polymer C, EPON ® 828, and UVR-6110

| Blend Composition, Wt % | | | Cloud Point |
|---|---|---|---|
| Polymer C | EPON ® 828 | UVR-6110 | (° C.) |
| 10 | 90 | 0 | 126 |
| 10 | 81 | 9 | 117 |
| 10 | 72 | 18 | 106 |
| 10 | 63 | 27 | 94 |
| 10 | 54 | 36 | 82 |
| 10 | 45 | 45 | 69 |
| 10 | 36 | 54 | 56 |
| 10 | 27 | 63 | 41 |
| 10 | 18 | 72 | <23 |
| 10 | 9 | 81 | <23 |
| 20 | 80 | 0 | 123 |
| 20 | 72 | 8 | 112 |
| 20 | 64 | 16 | 102 |
| 20 | 56 | 24 | 91 |
| 20 | 48 | 32 | 80 |
| 20 | 40 | 40 | 67 |
| 20 | 32 | 48 | 52 |
| 20 | 24 | 56 | 37 |
| 20 | 16 | 64 | <23 |
| 20 | 8 | 72 | <23 |

The cloud points of the binary blends of EPON® 828 resin and UVR-6110 are below room temperature for all compositions. The cloud points of the ternary blends listed in Table V are all well below 150° C. Thus, epoxidized polymers blended with aromatic and cycloaliphatic epoxy resins are suitable for use in the present invention.

### Example 5

The compatibility of epoxidized polymer F, having the structure I/S-B, with a mixture of EPON® 828 resin, a diglycidyl ether of bisphenol-A, and UVR-6110, a cycloaliphatic epoxy resin, is described. Table VI lists the cloud points for the blends having 10% and 20% epoxidized polymer.

TABLE VI
Cloud Points of Ternary Blends of Epoxidized Polymer F,
EPON ® 828, and UVR-6110

| Blend Composition, Wt % | | | Cloud Point |
|---|---|---|---|
| Polymer F | EPON ® 828 | UVR-6110 | (° C.) |
| 10 | 90 | 0 | 70 |
| 10 | 81 | 9 | 63 |
| 10 | 72 | 18 | 52 |
| 10 | 63 | 27 | 41 |
| 10 | 54 | 36 | 30 |
| 10 | 45 | 45 | 25 |
| 10 | 36 | 54 | <23 |
| 10 | 27 | 63 | <23 |
| 10 | 18 | 72 | <23 |
| 10 | 9 | 81 | <23 |
| 20 | 80 | 0 | 60 |
| 20 | 72 | 8 | 56 |
| 20 | 64 | 16 | 45 |
| 20 | 56 | 24 | 35 |
| 20 | 48 | 32 | 26 |
| 20 | 40 | 40 | <23 |
| 20 | 32 | 48 | <23 |
| 20 | 24 | 56 | <23 |
| 20 | 16 | 64 | <23 |
| 20 | 8 | 72 | <23 |

The cloud points of the ternary blends listed in Table VI are all well below 150° C. Thus, epoxidized polymers blended with aromatic and cycloaliphatic epoxy resins are suitable for use in the present invention.

### Example 6

A controlled amount of the epoxidized polymer having the structure I-B (polymer A or B) or (I-B), (polymer I) was added to EPON® 826 resin. In this example and the ones following, the amount of epoxidized polymer is expressed as the percentage by weight of the mass of epoxy resin plus epoxidized polymer. The total epoxy content of the blend was calculated from knowledge of the epoxy level of the epoxidized polymer and the epoxy equivalent weight of EPON® 826 resin (182 g/mole of epoxy functionality). A stoichiometric amount of MTHPA, or a mass such that there was present one anhydride group for every epoxy group, was measured into a separate container. Both masses were heated to 100° C. and then mixed together. 1 part of EMI per hundred parts of the epoxidized polymer plus EPON® 826 resin was added to accelerate the curing reaction. After thorough mixing, the mixture was poured into a glass mold at 120° C. The blend containing polymer A was optically clear at this point. The blend containing comparative polymer I was cloudy at this point. The mold was held at 120° C. for 2 hours and then heated to 150° and held at this temperature for 4 hours. The molds were then cooled to room temperature, the rubber modified epoxy resin plaques removed, and their physical properties tested. The mechanical properties of the resultant rubber modified epoxy resins are listed in Table VII.

In Table VII the control is an unmodified EPON® 826 resin. Cured resins containing epoxidized polymer A at the 10% level experienced a 261% increase in fracture energy (G_{IC}) while maintaining high tensile strengths and elongations and good flexural properties. Cured resins containing epoxidized polymer B experienced increases of 254% and 561% in fracture energy with 10% and 20% epoxidized polymer, respectively. Cured resins containing the comparative polymer I at the 10% level experienced a 22% increase in fracture energy while suffering loss of tensile strength and elongation and flexural strength and strain. These results demonstrate that polymers of the invention having structures of I-B with high epoxy content and thus improved compatibility are effective in achieving a superior balance of properties in epoxy resins cured with anhydrides. When poor compatibility of epoxidized polymer and epoxy resin results, as in the case of comparative Polymer I and EPON® 826 resin, only insignificant an increase in toughness is observed along with a significant degradation of tensile and flexural properties.

TABLE VII
Mechanical Properties of Modified EPON ® 826

| | |
|---|---|
| tensile fracture | flexural properties |

| | | | |
|---|---|---|---|
| modifier | tensile properties | toughness | stress at |

| and | strength | elongation | Young's | K_{IC} | G_{IC} | modulus | failure | strain at | T_{g} |
|---|---|---|---|---|---|---|---|---|---|
| level | (psi) | (%) | modulus (psi) | (psi in^{1/2}) | (J/m²) | (psi) | (psi) | failure (%) | (° C.) |
| Control | 11,850 | 6.6 | 434,000 | 452 | 74 | 483,000 | 19,300* | 5.0* | 156 |
| 10% A | 11,730 | 5.0 | 442,000 | 875 | 267 | 461,000 | 18,400* | 5.0* | 150 |
| 10% B | 11,440 | 4.5 | 423,900 | 849 | 262 | 461,000 | 18,800 | 5.7 | 148 |
| 20% B | 7,220 | 2.3 | 370,100 | 1096 | 489 | 399,000 | 15,300 | 4.7 | 140 |
| 10% I | 8,500 | 2.7 | 420,000 | 496 | 90 | 420,000 | 13,100 | 3.4 | 154 |

*Samples did not fail. Stress at 5% strain is reported.

### Example 7

A controlled amount of the epoxidized polymers having the structure I/S-B-I/S (polymers D and E) or I/S-B (polymers F and G) was added to EPON® 826 resin according to the protocol specified in Example 6. After thorough mixing of the epoxidized polymer, EPON® 826 resin, MTHPA, and EMI, the blend was poured into a mold at 120° C. The blends containing epoxidized polymers D, E, F, and G were optically clear at this point. Curing was continued as in Example 6. The mechanical properties of the resultant rubber modified epoxy resins are listed in Table VIII.

Cured resins containing epoxidized polymers D, E, F, and G at the 10% level experienced an increase in fracture energy (G_{IC}) ranging from 212% to 253% while maintaining high tensile strengths and elongations and good flexural properties. The cured resin containing epoxidized polymer G at the 20% level experienced a 435% increase in tensile fracture toughness while maintaining high tensile strengths and elongations and good flexural properties. These results demonstrate that polymers of the invention having structures of I/S-B-I/S or I/S-B are effective in achieving a superior balance of properties in epoxy resins cured with anhydrides.

TABLE VIII
Mechanical Properties of Modified EPON ® 826

| | |
|---|---|
| tensile fracture | flexural properties |

| | | | |
|---|---|---|---|
| modifier | tensile properties | toughness | stress at |

| and | strength | elongation | Young's | K_{IC} | G_{IC} | modulus | failure | strain at | T_{g} |
|---|---|---|---|---|---|---|---|---|---|
| level | (psi) | (%) | modulus (psi) | (psi in^{1/2}) | (J/m²) | (psi) | (psi) | failure (%) | (° C.) |
| Control | 11,850 | 6.65 | 434,000 | 452 | 74 | 483,000 | 19,300* | 5.0* | 156 |
| 10% D | 9,625 | 3.22 | 401,000 | 817 | 257 | 448,000 | 17,700 | 5.4 | 150 |
| 10% E | 10,430 | 3.17 | 446,000 | 829 | 238 | 474,000 | 16,600 | 3.9 | 140 |
| 20% F | 11,620 | 4.7 | 438,000 | 861 | 261 | 471,000 | 18,800 | 5.4 | 147 |
| 10% G | 11,590 | 4.1 | 444,000 | 816 | 231 | 478,000 | 19,100 | 5.0 | 145 |
| 20% G | 9,830 | 4.0 | 398,000 | 1,022 | 396 | 420,000 | 17,200 | 5.7 | 136 |

*Samples did not fail. Stress at 5% strain is reported.

### Example 8

A controlled amount of the epoxidized polymer having the structure I-S/B-I (polymer H) was added to EPON® 826 resin according to the protocol specified in Example 6. After thorough mixing of the epoxidized polymer, EPON® 826 resin, MTHPA, and EMI, the blend was poured into a mold at 120° C. The blends containing epoxidized polymer H were optically clear at this point. Curing was continued as in Example 6. The mechanical properties of the resultant rubber modified epoxy resins are listed in Table IX.

Cured resins containing epoxidized polymer H at the 10% and 20% level experienced increases in tensile fracture toughness (K_{IC}) of 108% and 144% respectively while maintaining good flexural properties. These results demonstrate that polymers of the invention having structures of I-B/S-I are effective in achieving a superior balance of properties in epoxy resins cured using anhydrides.

TABLE IX
Mechanical Properties of Modified EPON ® 826

| | tensile fracture | flexural properties | | | |
|---|---|---|---|---|---|
| | toughness | | stress at | strain at | |
| modifier and | K_{IC} | modulus | failure | failure | T_{g} |
| level | (psi in^{½}) | (psi) | (psi) | (%) | (° C.) |
| Control | 452 | 480,000 | 20,400 | 6.3 | 156 |
| 10% H | 939 | 458,000 | 18,600 | 6.2 | 148 |
| 20% H | 1,104 | 406,000 | 15,600 | 4.8 | 146 |

### Example 9

A controlled amount of epoxidized polymer E was added to EPON® 826 resin as specified in Example 6. Blends of anhydride curing agents MTHPA and DSA were made containing 10% and 20% DSA. A stoichiometric amount of the DSA/MTHPA blend, or a mass such that there was present one anhydride group for every epoxy group, was measured into a separate container. The epoxidized polymer/epoxy resin/anhydride curing agent/accelerator blend was made and mixed according to the protocol specified in Example 6. Upon pouring into the mold at 120° C., the blends were optically clear. Curing was continued as in Example 6. The mechanical properties of the resultant rubber modified epoxy resins are listed in Table X.

Incorporation of the epoxidized polymers leads to increases in fracture energy (G_{IC}) for the samples with 10% and 20% DSA curing agent levels of 408% and 137%, respectively, while maintaining high tensile strengths and elongations and good flexural properties. These results demonstrate that the epoxidized diene polymers are effective at achieving a superior balance of properties in curing systems containing mixtures of anhydrides.

TABLE X
Mechanical Properties of Modified EPON ® 826

| | |
|---|---|
| tensile fracture | flexural properties |

| | | | |
|---|---|---|---|
| modifier | tensile properties | toughness | stress at |

| and | strength | elongation | Young's | K_{IC} | G_{IC} | modulus | failure | strain at | T_{g} |
|---|---|---|---|---|---|---|---|---|---|
| level | (psi) | (%) | modulus (psi) | (psi in^{1/2}) | (J/m²) | (psi) | (psi) | failure (%) | (° C.) |
| Control | 10,940 | 6.7 | 436,000 | 467 | 79 | 468,000 | 19,000* | 5.0* | 136 |
| 90 MTHPA/10 DSA | | | | | | | | | |
| 10% E | 9,040 | 3.5 | 377,000 | 990 | 401 | 421,000 | 16,200 | 4.8 | 112 |
| 90 MTHPA/10 DSA | | | | | | | | | |
| Control | 9,840 | 7.7 | 393,000 | 464 | 86 | 444,000 | 17,700* | 5.0* | 120 |
| 80 MTHPA/10 DSA | | | | | | | | | |
| 20% E | 9,360 | 2.9 | 422,000 | 747 | 204 | 449,000 | 17,300 | 4.7 | 130 |
| 90 MTHPA/10 DSA | | | | | | | | | |

*Samples did not fail. Stress at 5% strain is reported.

### Example 10

A controlled amount of epoxidized polymer F having the structure I/S-B or epoxidized polymer C having the structure I-B was added to EPON® 828. 33 parts of EPI-CURE® 3140 (a polyamide curing agent) per hundred parts of EPON® 828 resin plus epoxidized polymer were added to the mixture and stirred by hand. A small amount (less than 1 part per hundred parts of EPON® 828 resin plus epoxidized polymer) of PC-1344/monofunctional glycidyl epoxy solution was added to aid in defoaming the mixture. The blend was degassed in vacuum and centrifuged. The blend was poured into a glass mold and held at room temperature at least 7 days before testing. The mechanical properties of the resultant rubber modified epoxy resins are listed in Table XI.

Incorporation of epoxidized polymers C and F at the 10% level leads to increases in fracture energy (G_{IC}) of 78% and 94%, respectively, while maintaining good tensile and flexural properties. These results demonstrate that the epoxidized polymers are effective at achieving a superior balance of properties in epoxy resins cured with polyamides.

TABLE XI
Mechanical Properties of Modified EPON ® 828

| | |
|---|---|
| tensile fracture | flexural properties |

| | | | |
|---|---|---|---|
| modifier | tensile properties | toughness | stress at |

| and | strength | elongation | Young's | K_{IC} | G_{IC} | modulus | failure | strain at | T_{g} |
|---|---|---|---|---|---|---|---|---|---|
| level | (psi) | (%) | modulus (psi) | (psi in^{1/2}) | (J/m²) | (psi) | (psi) | failure (%) | (° C.) |
| Control | 4,000 | 13.9 | 341,000 | 530 | 130 | 366,000 | 11,100* | 5.0* | 53 |
| 10% C | 5,260 | 5.5 | 332,000 | 708 | 231 | 335,000 | 9,800 | 4.9 | 59 |
| 10% F | 3,820 | 14.5 | 309,000 | 714 | 252 | 322,000 | 10,000* | 5.0* | 59 |

*Samples did not fail. Stress at 5% strain is reported.

### Example 11

A controlled amount of epoxidized polymer G having the structure I/S-B was added to EPON® 828 resin. An amount of diethyl toluene diamine was added so that there was one amine hydrogen for every epoxy group. The blend was heated to 100° C. and mixed thoroughly. The blend was then poured into a glass mold at 120° C. The mold was held at 120° C. for 2 hours and then heated to 150° C. and held at this temperature for 4 hours. The molds were then cooled to room temperature, the rubber modified epoxy resin plaques removed, and their physical properties tested. The mechanical properties of the resultant rubber modified epoxy resins are listed in Table XII.

Incorporation of the epoxidized polymer at the 10% level led to an increase in fracture energy (G_{IC}) of 50% while maintaining good tensile and flexural properties. Incorporation of 20% polymer G led to further increases in toughness. These results demonstrate that the epoxidized polymer is effective at achieving a superior balance of properties in epoxy resins cured with amines.

### Example 12

A blend was prepared having equal parts by weight of EPON® 828 resin and UVR-6110. A controlled amount of epoxidized polymer C was added. The modified, blended epoxidized resin was cured using MTHPA and EMI as in Example 6. The mechanical properties of the resultant rubber modified epoxy resins are listed in Table XIII. The results demonstrate that incorporation of the epoxidized polymers lead to significant increases in toughness of blended aromatic and cycloaliphatic epoxy resins.

TABLE XII
Mechanical Properties of Modified EPON ® 828

| | |
|---|---|
| tensile fracture | flexural properties |

| | | | |
|---|---|---|---|
| modifier | tensile properties | toughness | stress at |

| and | strength | elongation | Young's | K_{IC} | G_{IC} | modulus | failure | strain at | T_{g} |
|---|---|---|---|---|---|---|---|---|---|
| level | (psi) | (%) | modulus (psi) | (psi in^{1/2}) | (J/m²) | (psi) | (psi) | failure (%) | (° C.) |
| Control | 9,560 | 4.1 | 364,600 | 610 | 161 | 400,000 | 16,000* | 5.0* | 177 |
| 10% G | 9,670 | 6.1 | 322,300 | 716 | 242 | 345,000 | 12,300 | 4.4 | 177 |
| 20% G | 6,514 | 3.4 | 279,400 | 1026 | 553 | 278,000 | 10,700* | 5.0* | — |

*Samples did not fail. Stress at 5% strain is reported.

TABLE XIII
Mechanical Properties of Modified EPON ® 828

| | tensile fracture | flexural properties | | | |
|---|---|---|---|---|---|
| | toughness | | stress at | strain at | |
| modifier and | K_{IC} | modulus | failure | failure | T_{g} |
| level | (psi in^{½}) | (psi) | (psi) | (%) | (° C.) |
| Control | 430 | 490,000 | 19,900* | 5.0* | 186 |
| 10% C | 627 | 434,000 | 16,200 | 4.4 | 176 |

*Samples did not fail. Stress at 5% strain is reported.

### Example 13

The procedure of Example 11 was repeated with the exception that 1 part of EMI per 100 parts of the epoxidized polymer plus epoxy resin was added to catalyze the cure reaction of epoxidized polymer and epoxy resin. The mechanical properties of the resultant rubber modified epoxy resins are listed in Table XIV. These results demonstrate that incorporation of the epoxidized polymers leads to a significant increase in toughness in accelerated amine cured epoxy resins.

TABLE XIV
Mechanical Properties of Modified EPON ® 828

| | tensile fracture | flexural properties | | |
|---|---|---|---|---|
| | toughness | | stress at | strain at |
| modifier and | K_{IC} | modulus | failure | failure |
| level | (psi in^{½}) | (psi) | (psi) | (%) |

| | | | | |
|---|---|---|---|---|
| Control | 510 | 511,000 | 20,200* | 5.0* |
| 10% G | 804 | 431,000 | 16,400 | 4.9 |

*Samples did not fail. Stress at 5% strain is reported.

### Example 14

A controlled amount of epoxidized polymer G was added to a blend of 75% by weight EPON® 828 resin and 25% by weight cresyl glycidyl ether, a monofunctional epoxy resin. The average weight per epoxy was calculated. The blend was cured using MTHPA/EMI as in Example 6.

Cured plaques were obtained that showed no signs of surface or bulk segregation of the rubber. The plaques were rigid and the rubber was judged to be phase separated but homogeneously distributed throughout the sample. These results demonstrate that epoxidized polymers are useful rubber modifiers in blends of monofunctional and difunctional epoxy resins.

### Example 15

A controlled amount of epoxidized polymer G was added to a blend of 75% by weight EPON® 828 resin and 25% by weight trimethylolpropane triglycidyl ether, a trifunctional epoxy resin. The average weight per epoxy was calculated. The blend was cured using MTHPA/EMI as in Example 6.

Cured plaques were obtained that showed no signs of surface or bulk segregation of the rubber. The plaques were rigid and the rubber was judged to be phase separated but homogeneously distributed throughout the sample. These results demonstrate that epoxidized polymers are useful rubber modifiers in blends of multifunctional and difunctional epoxy resins.

### Example 16

A controlled amount of epoxidized polymer A having the structure I-B or epoxidized polymer F having the structure I/S-B was added to EPON® 828 resin. 33 parts of EPI-CURE® 3140 polyamide curing agent per hundred parts of EPON® 828 resin plus epoxidized polymer were added to the mixture and stirred by hand. A small amount (less than 1 part per hundred parts of EPON® 828 resin plus epoxidized polymer) of PC-1344 defoamer (manufactured by Monsanto) in cresyl glycidyl epoxy solution was added to aid in defoaming the mixture. The blend was degassed in vacuum and centrifuged. This cured epoxy was used to bond two aluminum strips together. The epoxy was cured one day at room temperature followed by one hour at 100° C. The lap shear strength was measured after cure and is listed in Table XV.

TABLE XV
Lap Shear Strength of Rubber Modified EPON ® 828

| Modifier and Level | Shear Strength (psi) |
|---|---|
| Control - no modifier | 917 |
| 10% A | 950 |
| 10% F | 1220 |

At 10% levels epoxidized polymers A and F yield increases in shear strength of 4% and 33%, respectively. These results demonstrate that incorporation of epoxidized polymers leads to increased strength of EPON® 828 resin adhesives.

### Example 17

A blend of 10% epoxidized polymer H having the structure I-S/B-I in EPON® 826 resin was made. A comparative blend containing 10% HYCAR 1300×8 carboxy terminated butadiene acrylonitrile copolymer manufactured by B. F. Goodrich in EPON® 826 resin was made. The viscosities were measured using a Brookfeld viscometer. The results are listed in Table XVI.

TABLE XVI
Viscosity of Blends of 10% Rubber in EPON ® 826

| | Viscosity-Poise | | |
|---|---|---|---|
| Polymer | @ 50° C. | @ 75° C. | @ 100° C. |
| H | 7.42 | 1.42 | 0.43 |
| HYCAR 1300x8 | 9.82 | 2.02 | 0.80 |

These results show that the blend containing epoxidized polymer H has a lower viscosity than the comparative blend containing HYCAR 1300×8. Thus, epoxidized polymer H possesses the processing advantage of giving blends with epoxy resins having lower viscosities.

The following examples were carried out using cycloaliphatic epoxy resins.

### Example 18

One important application of these epoxidized-rubber modified cycloaliphatic epoxy resin compositions is in coatings, especially coatings crosslinked via a UV initiated cationic cure reaction. The formulation used for the following experiments comprised 78.9% by weight of the cycloaliphatic epoxy resin, CYRACURE UVR6110, 3,4-epoxycyclohexyl-methyl-3,4-epoxycyclohexane carboxylate from Union Carbide, 20% of the epoxidized rubber, 1% of the cationic photoinitiator, CYRACURE UVI-6974, mixed triarylsulfonium hexafluoroantimonate salts from Union Carbide, and 0.1% of a wetting agent, FLUORAD FC430, a nonionic fluorochemical surfactant from 3M, which is used to reduce the surface tension of the coating and improve its ability to wet the aluminum substrate onto which it will be coated. The components were mixed manually at about 100° C. The blends were first checked for phase stability by inspecting them visually after they had stood undisturbed in a bottle overnight. If they were phase stable, they were warmed to about 70° C. and applied to aluminum substrates with a #40 wire rod at a dry film thickness of about 1 mil. The coatings were cured by exposure to UV radiation from 1 medium pressure Hg lamp at a line speed of 30 feet per minute (fpm). The coatings were then baked for 10 minutes at 120° C. to complete the cure.

The films were evaluated for mechanical properties. The appearance of the coatings was judged visually. The pencil hardness (gouge) of the coatings was measured according to the ASTM D3363 method of pushing successively softer pencil leads across the coating until the pencil lead will no longer gouge through the coating. The hardness scale (softest to hardest) is 6B<5B<4B<3B<2B <B<H3B<F<H<2H<3H1<4H<5H<6H. The methyl ethyl ketone (MEK) resistance of the coatings was measured according to the ASTM D4752 method of rubbing an MEK-moistened cloth across the coating for 200 cycles, or until breakthrough to the aluminum substrate occurred (one cycle equals one forward and one backward stroke). The value given in the table is the number of cycles the coating survived before breakthrough. Adhesion of the coatings was measured with the cross hatch adhesion test, ASTM D3359, Method B. In this test, a lattice pattern is scribed through the coating, pressure sensitive tape is applied and removed, and the amount of coating removed with the tape is rated. The scale ranges from 5 (no adhesion loss) to 0 (greater than 65% adhesion loss). The flexibility of the coatings was measured with the mandrel bend test according to ASTM D522, Method A. In this test, the coated 4-inch wide, 25 mil thick panel is bent around a standard conical mandrel and the percentage of the distance across the panel through which the coating cracks is measured (0% is no cracking, 100% is cracking of the coating completely across the panel). In some cases, flexibility was also judged by the wedge bend test. In this test, the coating on a 10 mil thick, 3 inch wide steel panel is bent with a wedge shaped die which varies the severity of the bend across the panel. On one edge, the panel is bent back upon itself. The wedge shaped die progressively reduces the severity of the bend across the panel until, on the other edge of the panel, the bend simulates that of a 0.1 inch diameter mandrel. The result is given as the percentage of the width of the panel across which the coating cracks. The polymers used to flexibilize the coatings are described in Table XVII. The results of coating evaluations are shown in Table XVIII.

TABLE XVII
Composition of Epoxidized Polymers

| | Base | | Styrene | Epoxy |
|---|---|---|---|---|
| | Polymer | Molecular Weights | Content | Level |
| Identity | Architecture | (in thousands) | (%) | (meq/g) |
| A | I-B | 0.88-4.08 | 0 | 2.1 |
| B | I-B | 0.88-4.08 | 0 | 3.6 |
| C | I-B | 0.88-4.08 | 0 | 5.2 |
| D | I/S-B-I/S | 1.18/0.68-3.82-0.68/0.39 | 16 | 0.8 |
| E | I/S-B-I/S | 1.18/0.68-3.82-0.68/0.39 | 16 | 2.2 |
| F | I/S-B-I/S | 1.18/0.68-3.82-0.68/0.39 | 16 | 3.4 |
| G | I-S/B-I | 1.0-2.5/1.5-1.0 | 39 | 2.2 |
| H | I-S/B | 1.18/0.68-3.82 | 12 | 3.5 |
| I | I/S-B | 1.18/0.68-3.82 | 12 | 4.5 |
| J | I/S-B | 1.18/0.68-3.82 | 12 | 5.5 |
| K | (I-B)₄ | (0.9-4.5)₄ | 0 | 2.0 |
| L | (I-B)₄ | (0.9-4.5)₄ | 0 | 3.85 |

In the base polymer architecture column of Table XVII, B represents polybutadiene blocks, I represents polyisoprene blocks, and S represents polystyrene blocks, respectively. Homopolymer blocks are separated by a dash. Random copolymer blocks are represented by I/S and S/B for randomly copolymerized isoprene and styrene and randomly copolymerized styrene and butadiene, respectively. Star or radial polymers having n arms are represented in parentheses, ( )ₙ. In all polymers the polybutadiene microstructure is 45% 1,2-addition.

TABLE XVIII
Compatibility and Cure of Polymer/Cycloaliphatic Epoxy Blends

| | Epoxy Content | Compatible | Thickness | | | Cross-hatch | Mandrel Bend | |
|---|---|---|---|---|---|---|---|---|
| Polymer | (meq/g) | ? | (mil) | Hardness | MEK Rubs | Adhesion | (%) | Appearance |
| A | 2.1 | No | — | — | — | — | — | Bad |
| B | 3.6 | YES | 1 | HB | >200 | 0 | 69 | Nice |
| C | 5.2 | Yes | 0.6 | H | >200 | 0 | 87 | Nice |
| D | 0.8 | No | — | — | — | — | — | Bad |
| E | 2.2 | Yes | 2.2 | H | >200 | 0 | 100 | Nice |
| F | 3.4 | Yes | 2.1 | H | >200 | 0 | 100 | Nice |
| G | 2.2 | Yes | 0.9 | HB | >200 | 5 | 0 | Nice |
| H | 3.5 | Yes | 0.4 | HB | >200 | 0 | 6 | Nice |
| I | 4.5 | Yes | 0.7 | HB | 154 | 0 | 0 | Nice |
| J | 5.5 | Yes | 1.1 | HB | >200 | 0 | 69 | Nice |
| K | 2 | No | — | — | — | — | | |
| L | 3.85 | Yes | 0.9 | HB | >200 | 0 | 0 | Nice |

The results show generally that the styrene-containing polymers can be made compatible with the epoxy resin by incorporating at least 2.0 meq/g of epoxy into the polymer. The polymers that do not contain styrene require at least 3.0 meq/g of epoxy to be compatible.

### Example 19

Polymer G from Example 18 was hydrogenated before epoxidation such that the B block was completely hydrogenated and the I blocks retained some unsaturation. The polymer was epoxidized to epoxy contents of 1.2, 1.3, and 1.9 meq/g. None of these polymers proved to be compatible in the formulation of Example 18.

Polymer D was hydrogenated in the same manner as described in the previous paragraph and epoxidized to an epoxy content of 3.0 meq/g. When evaluated in the formulation of Example 18, the polymer was incompatible. These experiments lead to the conclusion that hydrogenated polymers are less compatible than unsaturated polymers at the same epoxy content and that epoxidation to levels greater than 3.0 meq/gm would be required to make hydrogenated polymers which are compatible with cycloaliphatic epoxy resins.

We claim:

1. An epoxidized low viscosity polydiene polymer which has the structural formula
(A—B—Aₚ)ₙ—Yᵣ—(A_{q}—B)ₘ
wherein Y is a coupling agent or coupling monomers or initiator, and wherein A and B are polymer blocks which may be homopolymer blocks of conjugated diolefin monomers or copolymer blocks of conjugated diolefin monomers, the A blocks have a molecular weight of from 100 to 6,000 and the B blocks have a molecular weight of from 1000 to 15,000, the vinyl aromatic content of the polymer is less than 5% by weight, n is greater than 0, r is 0 or 1, m is greater than or equal to 0, n+m ranges from 1 to 100, and p and q may be 0 or 1; and wherein the polymer contains from 3.0 to 7.0 milliequivalents of epoxy per gram of polymer.

2. The polymer of claim 1 wherein the epoxy content is from 3.5 to 6.0 meq/g.

3. The polymer of claim 1 wherein the epoxy content is from 4.5 to 5.5 meq/g.

4. The polymer of claim 1 wherein p, r, and m are 0 and n is 1 so the polymer has the diblock structure A—B and A is a polymer block of isoprene and B is a polymer block of butadiene.

5. The polymer of claim 1 wherein p, r, and m are 0 and n is 1 so the polymer has the diblock structure A—B and A is a polymer block of 1, 4-butadiene and B is a polymer block of 1,2-butadiene.

6. The polymer of claim 1 wherein p, r, and m are 0 and n is 1 so the polymer has the diblock structure A—B and A is a polymer block of isoprene and B is a random copolymer block of butadiene and isoprene.

7. The polymer of claim 1 wherein p, r, and m are 0 and n is 1 so the polymer has the diblock structure A—B and A is a random copolymer block of isoprene and butadiene and B is a polymer block of butadiene.

8. An epoxidized low viscosity polydiene polymer which has the structural formula
(A—B—Aₚ)ₙ—Yᵣ—(A_{q}—B)ₘ
wherein Y is a coupling agent or coupling monomers or initiator, and wherein A and B are polymer blocks which may be homopolymer blocks of a conjugated diolefin monomer, or a copolymer block of conjugated diolefin monomers, one of A or B is a copolymer block of a conjugated diene and a vinyl aromatic hydrocarbon, the vinyl aromatic hydrocarbon comprises from 5 to 20% by weight of the epoxidized polymer, the A blocks have a molecular weight of from 100 to 6,000 and the B blocks have a molecular weight of from 1000 to 15,000, n is greater than 0, r is 0 or 1, m is greater than or equal to 0, n+m ranges from 1 to 100, and p and q may be 0 or 1; and wherein the polymer contains from 2.0 to 7.0 milliequivalents of epoxy per gram of polymer.

9. The polymer of claim 8 wherein the epoxy content is from 3.0 to 6.0 meq/g.

10. The polymer of claim 8 wherein the epoxy content is from 4.0 to 5.5 meq/g.

11. The polymer of claim 8 wherein p, r, and m are 0 and n is 1 so the polymer has the diblock structure A—B and A is a random copolymer block of isoprene and styrene and B is a polymer block of butadiene.

12. The polymer of claim 8 wherein p, r, and m are 0 and n is 1 so the polymer has the diblock structure A—B and A is a random copolymer block of 1 ,4-butadiene and styrene and B is a polymer block of 1,2-butadiene.

13. The polymer of claim 8 wherein p, r, and m are 0 and n is 1 so the polymer has the diblock structure A—B and A is a random copolymer block of isoprene and styrene and B is a random copolymer block of butadiene and isoprene.

14. The polymer of claim 8 wherein p, r, and m are 0 and n is 1 so the polymer has the diblock structure A—B and A is a polymer block of isoprene and B is a random copolymer block of butadiene and styrene.

15. The polymer of claim 8 wherein p, r, and m are 0 and n is 1 so the polymer has the diblock structure A—B and A is a random copolymer block of isoprene and butadiene and B is a random copolymer block of butadiene and styrene.

16. The polymer of claim 8 wherein p and n are l and r and m are 0 so the polymer has the triblock structure A—B—A and A is a random copolymer block of isoprene and styrene and B is a block of butadiene.

17. The polymer of claim 8 wherein p and n are 1 and r and m are 0 so the polymer has the triblock structure A—B—A and B is a random copolymer block of isoprene and styrene and A is a block of butadiene.

18. The polymer of claim 8 wherein p and n are 1 and r and m are 0 so the polymer has the triblock structure A—B—A and B is a random copolymer block of butadiene and styrene and A is a block of isoprene.

19. The polymer of claim 8 wherein p and n are 1 and r and m are 0 so the polymer has the triblock structure A—B—A and A is a random copolymer block of butadiene and styrene and B is a block of isoprene.

20. An epoxidized low viscosity polydiene polymer which has the structural formula
(A—B—Aₚ)ₙ—Yᵣ—(A_{q}—B)ₘ
wherein Y is a coupling agent or coupling monomers or initiator, and wherein A and B are polymer blocks which may be homopolymer blocks of a conjugated diolefin monomer, or a copolymer block of conjugated diolefin monomers, one of A or B is a copolymer block of a conjugated diene and a vinyl aromatic hydrocarbon, the vinyl aromatic hydrocarbon comprises from 20 to 60% by weight of the epoxidized polymer, the A blocks have a molecular weight of from 100 to 6,000 and the B blocks have a molecular weight of from 1000 to 15,000, n is greater than 0, r is 0 or 1, m is greater than or equal to 0, n+m ranges from 1 to 100, and p and q may be 0 or 1; and wherein the polymer contains from 1.0 to 7.0 milliequivalents of epoxy per gram of polymer.

21. The polymer of claim 20 wherein the epoxy content is from 1.5 to 6.0 meq/g.

22. The polymer of claim 20 wherein the epoxy content is from 2.0 to 4.5 meq/g.

23. The polymer of claim 20 wherein p, r, and m are 0 and n is 1 so the polymer has the diblock structure A—B and A is a random copolymer block of isoprene and styrene and B is a polymer block of butadiene.

24. The polymer of claim 20 wherein p, r, and m are 0 and n is 1 so the polymer has the diblock structure A—B and A is a random copolymer block of 1,4-butadiene and styrene and B is a polymer block of 1,2-butadiene.

25. The polymer of claim 20 wherein p, r, and m are 0 and n is 1 so the polymer has the diblock structure A—B and A is a random copolymer block of isoprene and styrene and B is a random copolymer block of butadiene and isoprene.

26. The polymer of claim 20 wherein p, r, and m are 0 and n is 1 so the polymer has the diblock structure A—B and A is a polymer block of isoprene and B is a random copolymer block of butadiene and styrene.

27. The polymer of claim 20 wherein p, r, and m are 0 and n is 1 so the polymer has the diblock structure A—B and A is a random copolymer block of isoprene and butadiene and B is a random copolymer block of butadiene and styrene.

28. The polymer of claim 20 wherein p and n are 1 and r and m are 0 so the polymer has the triblock structure A—B—A and A is a random copolymer block of isoprene and styrene and B is a block of butadiene.

29. The polymer of claim 20 wherein p and n are 1 and r and m are 0 so the polymer has the triblock structure A—B—A and B is a random copolymer block of isoprene and styrene and A is a block of butadiene.

30. The polymer of claim 20 wherein p and n are 1 and r and m are 0 so the polymer has the triblock structure A—B—A and B is a random copolymer block of butadiene and styrene and A is a block of isoprene.

31. The polymer of claim 20 wherein p and n are 1 and r and m are 0 so the polymer has the triblock structure A—B—A and A is a random copolymer block of butadiene and styrene and B is a block of isoprene.
